(19) United States
(12) Patent Application Publication
(10) Pub. No.: US 2019/0219774 A1
(43) Pub. Date: Jul. 18, 2019

(54) OPTICAL CONNECTOR AND OPTICAL CONNECTOR PRODUCTION METHOD

(71) Applicant: SUMITOMO ELECTRIC INDUSTRIES, LTD., Osaka-shi, Osaka (JP)

(72) Inventors: Yoshikyo TAMEKUNI, Yokohama-shi, Kanagawa (JP); Dai SASAKI, Yokohama-shi, Kanagawa (JP); Tomomi SANO, Yokohama-shi, Kanagawa (JP)

(73) Assignee: SUMITOMO ELECTRIC INDUSTRIES, LTD., Osaka-shi, Osaka (JP)

(21) Appl. No.: 16/327,343

(22) PCT Filed: Aug. 14, 2017
(86) PCT No.: PCT/JP2017/029277

§ 371 Date: Feb. 22, 2019

(30) Foreign Application Priority Data
Aug. 25, 2016 (JP) 2016-164981

(51) Int. Cl. G02B 6/38; G02B 6/32

(52) U.S. Cl. CPC G02B 6/3825; G02B 6/32; G02B 6/387; G02B 6/3853; G02B 6/3838; G02B 6/3887

(57) ABSTRACT

Disclosed is an optical connector, the optical connector being one of a pair of optical connectors connected to face each other along a first direction. This optical connector comprises a ferrule that holds an optical fiber, the ferrule exposing an end surface of the optical fiber from a ferrule end surface closer to the other optical connector in the first direction, and a ferrule cap that covers the ferrule. The ferrule cap has a light transmission portion through which a light path extending from the end surface of the optical fiber is made to pass. An end of the ferrule cap except for the light transmission portion is positioned closer to the other optical connector with respect to the end surface of the optical fiber and the light transmission portion in the first direction.

### TECHNICAL FIELD

The present invention relates to an optical connector and an optical connector production method. The present application claims the benefit of priority of Japanese Patent Application No. 2016-164981 filed on Aug. 25, 2016, the contents of which are entirely incorporated herein by reference.

### BACKGROUND ART

Patent Literature 1 discloses an example of an optical connector used to connect optical fibers. In this optical connector, two connector bodies inserted so as to expose end surfaces of optical fibers are abutted against each other in such a manner that connecting end faces thereof come into contact with each other. In other words, the abutting is done in such a manner that the end surfaces of the optical fibers come into contact with each other. The end surfaces of the optical fibers are curved to be concave with respect to the connecting end face of the connector body, and peripheral edges of the end surfaces of the optical fibers abut against the connecting end face of the connector body.

### CITATION LIST

### Patent Literature

Patent Literature 1: Japanese Unexamined Patent Publication No. H6-289254

Patent Literature 2: Japanese Unexamined Patent Publication No. 2003-255184

Patent Literature 3: Japanese Unexamined Patent Publication No. 2003-166464

Patent Literature 4: Japanese Unexamined Patent Publication No. 2006-066182

Patent Literature 5: Japanese Unexamined Patent Publication No. 2012-003245

Patent Literature 6: Japanese Unexamined Patent Publication No. 2000-137143

Patent Literature 7: Japanese Unexamined Patent Publication No. 2014-038128

### SUMMARY OF INVENTION

An optical connector according to the present disclosure is an optical connector that is one of a pair of optical connectors connected to face each other along a first direction. The optical connector comprises a ferrule that holds an optical fiber, the ferrule exposing an end surface of the optical fiber from a ferrule end surface closer to the other optical connector in the first direction, and a ferrule cap that covers the ferrule. The ferrule cap has a light transmission portion, a light path extending from the end surface of the optical fiber being made to pass through the light transmission portion. An end of the ferrule cap is positioned closer to the other optical connector with respect to the end surface of the optical fiber in the first direction.

### BRIEF DESCRIPTION OF DRAWINGS

FIG. 1 is a sectional view illustrating a configuration of an optical connection structure including an optical connector according to a first embodiment, and illustrates a section along a connecting direction of a pair of optical connectors.

FIG. 2 is a perspective view illustrating an outer appearance of a ferrule cap of the optical connector illustrated in FIG. 1.

FIG. 3 is an enlarged view of a tip end of the optical connector illustrated in FIG. 1.

FIG. 4 is a diagram illustrating another example of a light transmission portion of the ferrule cap of the optical connector according to the first embodiment.

FIG. 5 is a sectional view illustrating a configuration of a ferrule cap according to a modification example.

FIG. 6 is a sectional view illustrating a configuration of a ferrule cap according to another modification example.

FIG. 7 is a diagram schematically illustrating a configuration of an OCT device to which an optical connection structure according to a second embodiment is applied.

### DESCRIPTION OF EMBODIMENTS

### Technical Problem Solved by Disclosure

In an optical connector, in a case that an end surface of an optical fiber is abutted to be brought into contact with an end surface of a coupled optical fiber, if attachment and detachment of an optical connector is repeated, the end surfaces of the optical fibers are likely to be damaged. If the end surface of the optical fiber, which lights are incident on or emitted from, are damaged caused by such an attachment and detachment repetition, an optical coupling efficiency is reduced so that an optical property degrades. For this reason, the optical connector described in Patent Literature 1 is provided, for example. However, in the optical connector described in Patent Literature 1, a curvature radius of the end surface of the optical fiber which is curved to be concave is required to be extremely small. It is difficult to manage such an extremely small curvature radius in terms of molding.

### Advantageous Effects of Disclosure

According to an optical connector and a production method therefor in the present disclosure, degradation of an optical property caused by a repetition of attachment and detachment can be suppressed.

### Description of Embodiments of Invention

First, contents of embodiments of the present invention are listed and described. An optical connector according to an embodiment of the present invention is an optical connector, the optical connector being one of a pair of optical connectors connected to face each other along a first direction. The optical connector comprises a ferrule that holds an optical fiber, the ferrule exposing an end surface of the optical fiber from a ferrule end surface closer to the other optical connector in the first direction, and a ferrule cap that covers the ferrule. The ferrule cap has a light transmission portion, a light path extending from the end surface of the optical fiber being made to pass through the light transmission portion. An end of the ferrule cap except for the light transmission portion is positioned closer to the other optical connector with respect to the end surface of the optical fiber and the light transmission portion in the first direction.

In the above optical connector, the end of the ferrule cap is positioned closer to the other optical connector with respect to the end surface of the optical fiber and the light transmission portion in the first direction that is the connecting direction of the optical connector. By this configuration, when the optical connector is connected, the end of the ferrule cap is brought into contact with the coupled optical connector, and the end surface of the optical fiber and the light transmission portion are unlikely to be in contact with the coupled optical connector. Thus, the degradation of the optical property can be suppressed which is caused by damage of the end surfaces, such as the end surface of the optical fiber and the end surface of the light transmission portion, positioned on the light path. Unlike the configuration described in Patent Literature 1, it is easy to manage the dimension from the end of the ferrule cap to the end surface of the optical fiber or the end surface of the light transmission portion in terms of forming, where this dimension can be defined to such an extent that the end surface of the optical fiber or the end surface of the light transmission portion is not brought into contact with the coupled optical connector. Therefore, according to the above optical connector, the degradation of the optical property caused by the repetition of the attachment and detachment can be suppressed.

In the above optical connector, the light transmission portion may be made of the light transmissive material. This makes it possible to preferably achieve the light transmission portion. In this case, the light transmission portion may have the lens which is optically coupled with the optical fiber. In the above optical connector, a gap is generated between the end surface of the optical fiber and the coupled optical connector depending on a distance between the end surface of the optical fiber and one end of the ferrule cap. Therefore, the lens being provided to the light transmission portion can increase the optical coupling efficiency between the end surface of the optical fiber and the coupled optical connector.

The optical connector may further comprise an adhesive or a refractive index matching material arranged between the ferrule end surface and the end surface of the optical fiber, and the light transmission portion. The adhesive or the refractive index matching material matches refractive indexes of the optical fiber and the light transmission portion. This can suppress occurrence of a reflected return light due to a Fresnel reflection caused by a gap generated between the optical fiber and the light transmission portion. The ferrule end surface and the end surface of the optical fiber may be inclined with respect to a plane perpendicular to an optical axis of the optical fiber, and the light transmission portion may face the ferrule end surface and the end surface of the optical fiber, and may have a surface inclined along the ferrule end surface and the end surface of the optical fiber. This can suppress the occurrence of the reflected return light on the surface of the light transmission portion which faces the optical fiber end surface and the optical fiber end surface.

The above optical connector may further comprise a housing that accommodates the ferrule and the ferrule cap therein and has a first step on an inner wall. The ferrule cap may have a second step on an outer surface. The first step and the second step may abut against each other such that the ferrule cap may be restrained from moving relatively to the housing away from the other optical connector. This can prevent the ferrule cap from dropping out of the optical connector when extracting the optical connector from the adapter.

In the above optical connector, the ferrule cap may have a portion inserted into a sleeve accommodated in an adapter. The portion art may have a columnar surface-shaped outer periphery centered on the optical axis of the optical fiber. A diameter of the outer periphery may be 1.25 mm or 2.5 mm. By this configuration, an outer diameter of the portion of the ferrule cap inserted into the sleeve becomes equal to an outer diameter of a ferrule of a general-purpose optical connector, and therefore, the above optical connector can be connected to a general-purpose adapter.

In the above optical connector, the ferrule cap may be configured to include a resin material, and the ferrule cap may have a hard member or a hard film which has a hardness higher than the resin material constitutes the one end. This improves a durability of the end of the ferrule cap, and therefore, it is possible to suppress degradation of the end of the ferrule cap caused by the repetition of the attachment and detachment of the optical connector.

An optical connector production method according to an embodiment of the present invention is an optical connector production method for producing any one of the above optical connectors, wherein at least the light transmission portion in the ferrule cap is made of a resin material, and the method comprises a step of molding the ferrule and the ferrule cap to be one form using a direct molding method. In this way, the direct molding method is used to cast a resin into a mold to be cured in a state where the ferrule is fixed to the mold, such that it is easy to mold the ferrule and the ferrule cap to be one form. Moreover, since a gap is unlikely to be generated between the end surface of the optical fiber and the ferrule cap, the occurrence of the reflected return light due to the Fresnel reflection can be suppressed.

### Detailed Description of Embodiment of Invention

Specific examples of the optical connector and the production method therefor according to the embodiments of the invention are described with reference to the drawings. The invention is not limited to the examples, and is intended to include the meanings shown by the scope of the Claims and equivalent to the scope of the Claims, and all changes in the scope thereof. In the following description, the same components in description of the drawings are designated by the same reference signs, and the duplicated description is omitted.

### First Embodiment

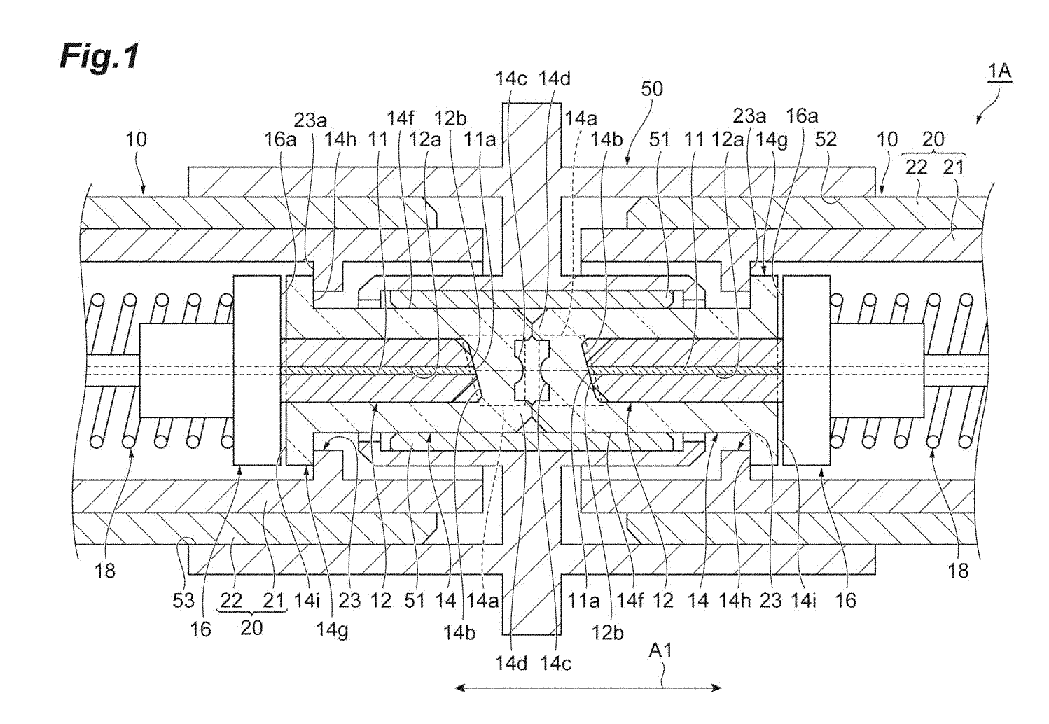

FIG. 1 is a sectional view illustrating a configuration of an optical connection structure 1A including an optical connector 10 according to a first embodiment, and illustrates a section along a connecting direction of a pair of optical connectors 10. As illustrated in FIG. 1, the optical connection structure 1A includes a pair of optical connectors 10 that are connected to face each other along a first direction A1, and an adapter 50 that accommodates the pair of optical connectors 10. Since a configuration of each of a pair of optical connectors 10 is the same with each other, the configuration of one of the optical connectors 10 is mainly described in the following description.

The optical connector 10 includes a ferrule 12, a ferrule cap 14, a flange 16, a coil spring 18, and a housing 20. The ferrule 12 is a substantially columnar shaped member with a center axis direction thereof being the first direction A1, and made of an inorganic material (ceramics) such as zirconia, for example. The ferrule 12 has a fiber inserted hole 12a into which the optical fiber 11 is inserted, and the fiber inserted hole 12a extends on a center axis line of the ferrule 12. One end of the optical fiber 11 is inserted into the fiber inserted hole 12a so that the optical fiber 11 is held. A portion of the optical fiber 11 inserted into the fiber inserted hole 12a is a bare fiber whose jacket made of a resin is removed. The ferrule 12 has a flat ferrule end surface 12b on one end closer to other optical connector 10 in the first direction A1. The end surface 11a of the optical fiber 11 is exposed from the ferrule end surface 12b. In an example, the end surface 11a of the optical fiber 11 and the ferrule end surface 12b are flush with each other, and these are collectively ground and formed. In order to avoid a reflected return light, the ferrule end surface 12b and the end surface 11a of the optical fiber 11 are inclined with respect to a plane perpendicular to an optical axis of the optical fiber 11. The inclined angle is 8°, for example. A peripheral edge of the ferrule end surface 12b is cut to be tapered. The other end of the ferrule 12 is supported by the flange 16.

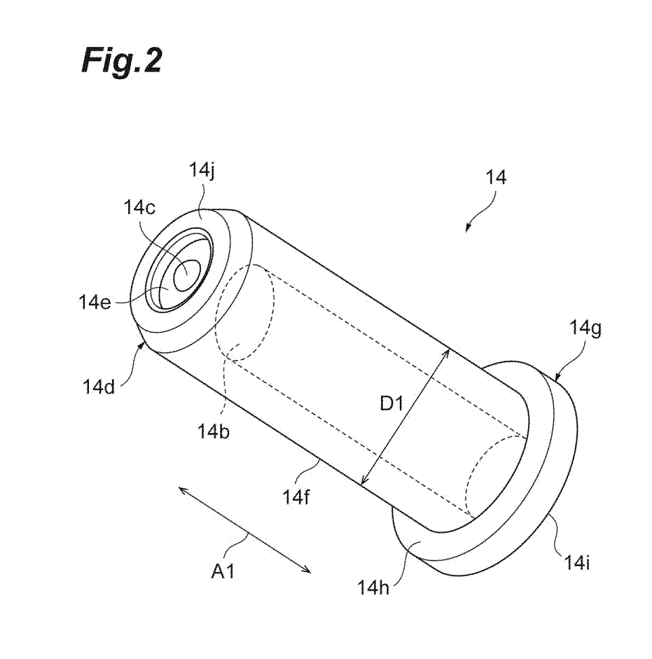

FIG. 2 is a perspective view illustrating an outer appearance of the ferrule cap 14. As illustrated in FIG. 1 and FIG. 2, the ferrule cap 14 is a member covering the ferrule 12, and has a substantially cylindrical shape whose one end is closed. The ferrule cap 14 has, on one end of the cylindrical shape, a light transmission portion 14a (see FIG. 1) through which a light path (illustrated by a dashed-dotted line in FIG. 1) extending from the end surface 11a of the optical fiber 11 is made to pass. The light transmission portion 14a is made of a light transmissive material such as a transparent resin. The ferrule cap 14 may be entirely made of a light transmissive material. The light transmission portion 14a has a rear surface 14b which is arranged closer to the other optical connector 10 with respect to the end surface 11a of the optical fiber 11 and the ferrule end surface 12b, and faces the end surface 11a of the optical fiber 11 and the ferrule end surface 12b. The rear surface 14b of the light transmission portion 14a is inclined along the ferrule end surface 12b and the end surface 11a of the optical fiber 11. This can suppress occurrence of a reflected return light on the rear surface 14b of the light transmission portion 14a. In an example, an inclined angle of the rear surface 14b to the plane perpendicular to the optical axis of the optical fiber 11 matches the inclined angle thereto of the ferrule end surface 12b and the end surface 11a of the optical fiber 11.

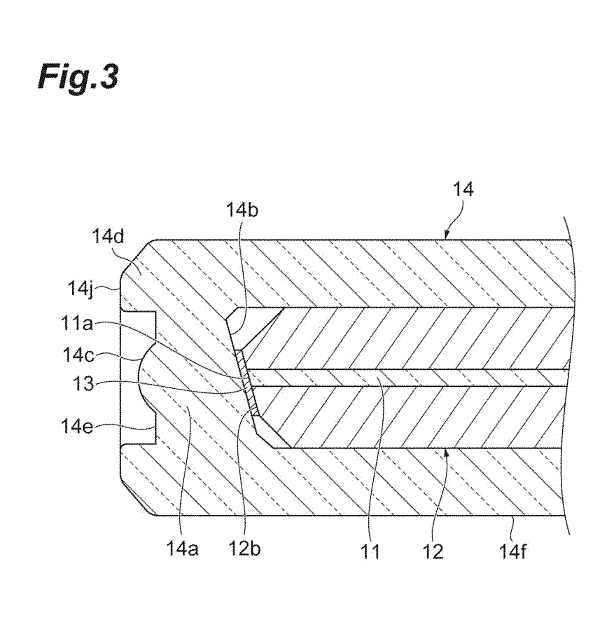

FIG. 3 is an enlarged view of a tip end of the optical connector illustrated in FIG. 1. Provided between the rear surface 14b of the light transmission portion 14a, and the end 11a of the optical fiber 11 and the ferrule end surface 12b is a light transmissive matching film 13 consisting of an adhesive or refractive index matching material which matches refractive indexes of the optical fiber 11 and the light transmission portion 14a. This can suppress the occurrence of the reflected return light due to a Fresnel reflection caused by a gap generated between the optical fiber 11 and the light transmission portion 14a. A refractive index of the matching film 13 may be matched to that of the optical fiber 11 (quartz) or the light transmission portion 14a, or may be an intermediate value of the refractive index of the optical fiber 11 (quartz) and the refractive index of the light transmission portion 14a.

On the other hand, the rear surface 14b of the light transmission portion 14a, and the end surface 11a of the optical fiber 11 and ferrule end surface 12b may be closely contact with each other with no member being interposed. In this case, a direct molding method may be used to mold the ferrule 12 and the ferrule cap 14 to be one form, for example. In other words, the direct molding method is used to cast a resin into a mold to be cured in a state where the ferrule 12 is fixed to the mold and form the ferrule cap 14. This can easily make the rear surface 14b of the light transmission portion 14a closely contact with the end surface 11a of the optical fiber 11 and the ferrule end surface 12b.

Again, refer to FIG. 1 and FIG. 2. The light transmission portion 14a has a lens 14c optically coupled with the optical fiber 11. The lens 14c collimates light emitted from the optical fiber 11, and focuses light incident on the optical fiber 11 from the other optical connector 10. In the embodiment, the lens 14c is formed to be one form with the other portions of the light transmission portion 14a at the end surface closer to the other optical connector 10 in the light transmission portion 14a. The lens 14c includes a substantially semispherical convex portion formed on an end surface 14e of the light transmission portion 14a closer to the optical connector 10. According to this configuration, a tip end of the lens 14c is a portion the closest to the other optical connector 10 in the light transmission portion 14a. A beam diameter and a beam divergence angle are adjusted depending on a shape of the lens 14c and a distance between the lens 14c and the end surface 11a of the optical fiber 11.

An end 14j (see FIG. 2) of the ferrule cap 14 except for the light transmission portion 14a closer to the other optical connector 10 in the first direction A1 is positioned closer to the other optical connector 10 with respect to the end surface 11a of the optical fiber 11 and the light transmission portion 14a. To be more specific, the ferrule cap 14 has a tip end 14d positioned closer to the other optical connector 10 with respect to the light transmission portion 14a. The tip end 14d is provided to surround the light transmission portion 14a and projected from the end surface 14e of the light transmission portion 14a toward the other optical connector 10. In other words, the end surface of the ferrule cap 14 closer to the other optical connector 10 is provided with a recess, a bottom face of the recess constitutes the end surface 14e of the light transmission portion 14a closer to the other optical connector 10. Seen in the first direction A1, a shape of the bottom face of the recess is a circle shape centered on the optical axis of the optical fiber 11.

The ferrule cap 14 has an inserted portion inserted into a split sleeve 51 of the adapter 50 described later. The inserted portion includes a cylindrical portion and a portion provided around the light transmission portion 14a, and has a columnar surface-shaped outer periphery 14f centered on the optical axis of the optical fiber 11. A diameter D1 of the outer periphery 14f may be 1.25 mm or 2.5 mm the same as a general zirconia ferrule. The diameter D1 of the outer periphery 14f may be slightly varied from these values owing to a manufacturing error.

The ferrule cap 14 further has a step 14g. The step 14g is formed on the outer periphery 14f of the ferrule cap 14 and projects toward an outer side in a circumferential direction of the ferrule cap 14. In an example, the step 14g consists of a flanged portion foamed on a rear end of the ferrule cap 14. The step 14g has a surface 14h directed frontward in an insertion direction (that is, facing the other optical connector 10). This surface 14h abuts against a surface 23a of the step 23 provided in the housing 20 described later.

As illustrated in FIG. 1, the flange 16 is a member supporting the other end of the ferrule 12 and made of a metal, for example. The flange 16 has a columnar shape extending in the first direction A1 and has a through-hole therein through which the optical fiber 11 is made to pass. The flange 16 has an end surface 16a closer to the other optical fiber 11 in the first direction A1. The ferrule 12 is supported on the end surface 16a, and the end surface 16a thereof faces the other end surface 14i of the ferrule cap 14. However, a slight clearance is provided between the other end surface 14i of the ferrule cap 14 and the end surface 16a of the flange 16 in consideration of a dimension error of the ferrule cap 14 (generated mainly by shrinkage when a resin curing) in the first direction A1. By providing such a clearance, a gap is prevented from being generated between the rear surface 14b of the light transmission portion 14a, and the ferrule end surface 12b and the end surface 11a of the optical fiber 11.

The coil spring 18 is an elastic member biasing the flange 16 toward the other optical connector 10 in the first direction A1. One end of the coil spring 18 abuts against the flange 16, and the other end thereof is supported by the housing 20.

The housing 20 is a container that accommodates the ferrule 12, the ferrule cap 14, the flange 16, and the coil spring 18 described above. The housing 20 is configured to include an inner housing 21 and an outer housing 22. The inner housing 21 accommodates the ferrule 12, the ferrule cap 14, the flange 16, and the coil spring 18. The outer housing 22 covers the inner housing 21 and mates with the adapter 50 described later.

The inner housing 21 has the step 23. The step 23 is formed on an inner wall of the inner housing 21 facing the outer periphery 14f of the ferrule cap 14, and projects toward the outer periphery 14f of the ferrule cap 14. The step 23 has the surface 23a facing backward in the insertion direction. This surface 23a abuts against the surface 14h of the step 14g of the ferrule cap 14 described above. This restrains the ferrule cap 14 from moving relatively to the housing 20 away from the other optical connector 10. Therefore, the ferrule cap 14 can be prevented from dropping out of the ferrule 12 owing to a friction force between the ferrule cap 14 and the split sleeve 51 when extracting the optical connector 10 from the adapter 50.

The adapter 50 is a member that holds a pair of optical connectors 10 to be in a state of being connected to each other. The adapter 50 extends in the first direction A1, and has an opening 52 that accepts one optical connector 10 on one end thereof in the first direction Al and an opening 53 that accepts the other optical connector 10 on the other end thereof in the first direction A1. The adapter 50 further has the cylindrical split sleeve 51 that has a center axis line extending in the first direction A1. When one optical connector 10 is inserted into the opening 52, the ferrule cap 14 of the optical connector 10 is inserted from one side of the split sleeve 51 to mate with the split sleeve 51. When the other optical connector 10 is inserted into the opening 53, the ferrule cap 14 of the other optical connector 10 is inserted from the other side of the split sleeve 51 to mate with the split sleeve 51. Then, these ferrule caps 14 abut against each other inside the split sleeve 51. Specifically, the ends 14j (the end surfaces of the respective tip ends 14d) in the first direction A1 of these ferrule caps 14 abut against each other. This generates a gap between one light transmission portion 14a and the other light transmission portion 14a, and these light transmission portions 14a face each other via this gap and are optically coupled.

A description is given of advantageous effects obtained from the optical connector 10 according to the embodiment described above. In the optical connector 10, the end 14j of the ferrule cap 14 is positioned closer to the other optical connector 10 with respect to the end surface 11a of the optical fiber 11 and the light transmission portion 14a in the first direction A1 that is the connecting direction of the optical connector 10. By this configuration, when the optical connector 10 is connected, the end 14j of the ferrule cap 14 is brought into contact with the coupled optical connector 10, and the end surface 11a of the optical fiber 11 and the light transmission portion 14a are unlikely to be in contact with the coupled optical connector 10. Therefore, the degradation of the optical property can be suppressed which is caused by damage of the end surfaces positioned on the light path such as the end surface 11a of the optical fiber 11 and the end surface 14e of the light transmission portion 14a. Unlike the configuration described in Patent Literature 1, it is easy to manage the dimension from the end 14j of the ferrule cap 14 to the end surface 11a of the optical fiber 11 or the end surface 14e of the light transmission portion 14a in terms of forming, where this dimension can be defined to such an extent that the end surface 11a of the optical fiber 11 or the end surface 14e of the light transmission portion 14a is not brought into contact with the coupled optical connector 10. Therefore, according to the optical connector 10 of the embodiment, the degradation of the optical property caused by the repetition of the attachment and detachment can be suppressed.

In the technologies described in Patent Literatures 2 and 4, a light transmissive member is arranged between the optical fiber end surface and a ball lens. In such a configuration, since the light transmissive member is brought into contact with the optical fiber end surface, the optical fiber end surface is likely to be damaged by repeating the attachment and detachment of the optical connector so that the optical property degrades. In the technology described in Patent Literature 6, a translucent elastic body is adhered and formed on the optical fiber end surface. In such a configuration, the surface of the elastic body is likely to be damaged by repeating the attachment and detachment of the optical connector so that the optical property degrades. According to the optical connector 10 of the embodiment, these problems can be solved to suppress the degradation of the optical property caused by the repetition of the attachment and detachment.

The light transmission portion 14a may be made of the light transmissive material. This makes it possible to preferably achieve the light transmission portion 14a. In this case, the light transmission portion 14a may have the lens 14c which is optically coupled with the optical fiber 11. In the optical connector 10 according to the embodiment, a gap is generated between the end surface 11a of the optical fiber 11 and the coupled optical connector 10 depending on a distance between the end surface 11a of the optical fiber 11 and one end of the ferrule cap 14. Therefore, the lens 14c being provided to the light transmission portion 14a can increase the optical coupling efficiency between the end surface 11a of the optical fiber 11 and the coupled optical connector 10. A connection state (adhesion state) between the ferrule end surface 12b and the rear surface 14b of the light transmission portion 14a can be also easily checked from the end surface 14e.

The diameter D1 of the outer periphery 14f of the inserted portion of the ferrule cap 14 may be 2.5 mm. By this configuration, the diameter D1 becomes equal to an outer diameter of a ferrule of a general-purpose optical connector such as an SC connector or an FC connector. Alternatively, the diameter D1 may be 1.25 mm. By this configuration, the diameter D1 becomes equal to an outer diameter of a ferrule of a general-purpose optical connector such as an MU connector or an LC connector. Therefore, the optical connector 10 according to the embodiment can be connected to a general-purpose adapter. In this case, an optical reference plane with respect to a mechanical reference plane may further preferably conform with a dimension defined by an industrial standard for the SC connector (FC connector, MU connector, or LC connector).

When the ferrule cap 14 is formed, the direct molding method may be used to mold the ferrule 12 and the ferrule cap 14 to be one form, as described above. This makes it possible to easily mold the ferrule 12 and the ferrule cap 14 to be one form. Moreover, since a gap is unlikely to be generated between the end surface 11a of the optical fiber 11 and the ferrule cap 14, the occurrence of the reflected return light due to the Fresnel reflection can be suppressed. Additionally, since relative positions of the ferrule 12 and the ferrule cap 14 can be accurately defined, the optical axis of the optical fiber 11 can be accurately conformed with the optical axis of the lens 14c.

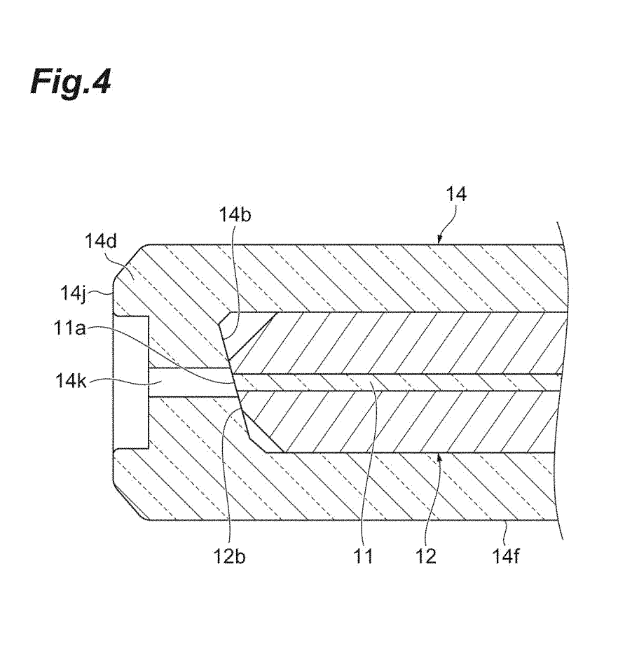

Although the embodiment illustrates the case where the ferrule cap 14 entirely consist of the transparent resin, in the ferrule cap 14, at least light transmission portion 14a may have the light transmissive property and other portion than the light transmission portion 14a may consist of a material blocking the light. Although the embodiment illustrates the case where the light transmission portion 14a is made of the light transmissive material, the light transmission portion may be a vacant hole 14k as illustrated in FIG. 4. In this case, the lens 14c is not provided, and the end surface 11a of the optical fiber 11 of one optical connector 10 is optically coupled with the end surface 11a of the optical fiber 11 of the other optical connector 10 via a gap.

### Modification Example

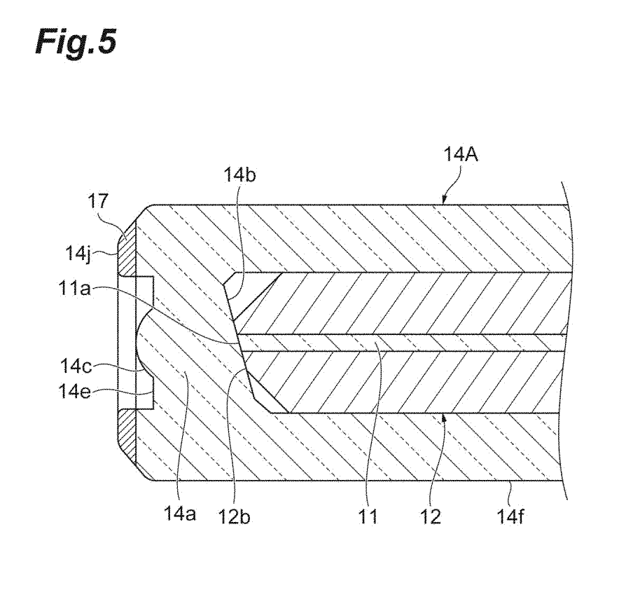

FIG. 5 is a sectional view illustrating a configuration of a ferrule cap 14A according to a modification example of the embodiment. A difference between the ferrule cap 14A in the modification example and the ferrule cap 14 in the above embodiment is the configuration of the end 14j closer to the other optical connector 10. In the modification example, the ferrule cap 14A further has a hard member 17. The hard member 17 has a hardness higher than the resin material constituting other portion of the ferrule cap 14A, and constitutes the end 14j of the ferrule cap 14A. In other words, the hard member 17 is exposed on the end 14j of the ferrule cap 14A. The hard member 17 consists of materials such as diamond-like carbon (DLC), a polyetheretherketone (PEEK) resin, or ceramic, for example. This improves a durability of the end 14j of the ferrule cap 14A, and therefore, it is possible to suppress degradation of the end 14j of the ferrule cap 14A caused by the repetition of the attachment and detachment of the optical connector 10 and keep the optical property good. The hard member 17 may be provided to only one of a pair of optical connectors 10 which requires the durability.

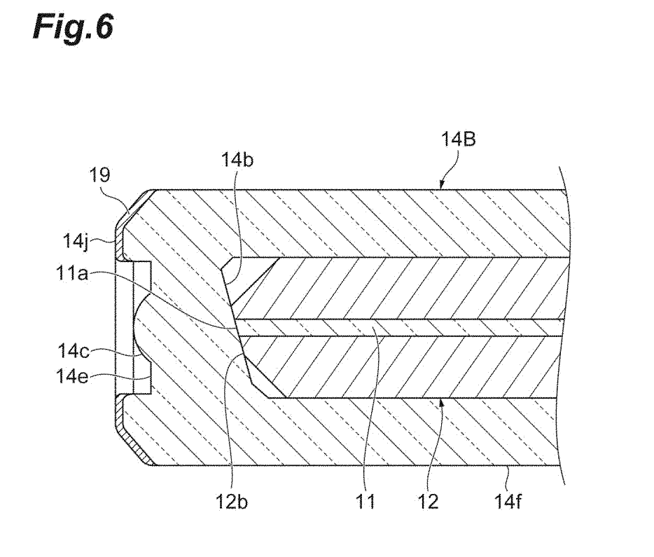

FIG. 6 is a sectional view illustrating a configuration of a ferrule cap 14B according to another modification example of the embodiment. In the modification example, the ferrule cap 14B further has a coated hard film 19. The hard film 19 has a hardness higher than the resin material constituting other portion of the ferrule cap 14B, and constitutes the end 14j of the ferrule cap 14B. In other words, the hard film 19 is exposed on the end 14j of the ferrule cap 14B. The hard film 19 consists of a DLC coating, a PEEK resin film coating, or a ceramic coating, for example. This improves a durability of the end 14j of the ferrule cap 14B, and therefore, it is possible to suppress degradation of the end 14j of the ferrule cap 14B caused by the repetition of the attachment and detachment of the optical connector 10 and keep the optical property good. The hard film 19 may be provided to only one of a pair of optical connectors 10 which requires the durability. A film thickness of the hard film is 3 μm to 20 μm, for example.

### Second Embodiment

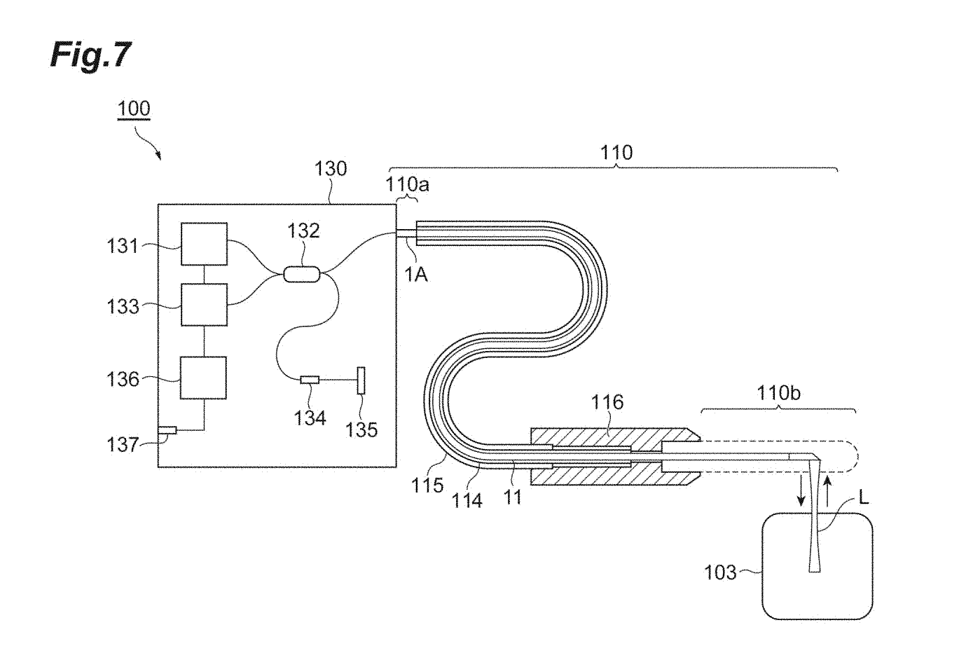

FIG. 7 is a diagram schematically illustrating a configuration of an optical coherence tomography (OCT) device 100 to which the optical connection structure is applied. The OCT device 100 includes an optical probe (catheter) 110 and a measurement unit 130 to acquire an optical coherence tomography image of a target site 103.

The optical probe 110 includes a proximal end 110a, a distal end 110b, and a handpiece 116 arranged between the proximal end 110a and the distal end 110b. The optical probe 110 has the optical fiber 11 transmitting light between the proximal end 110a and the distal end 110b. The optical fiber 11 is optically connected to the measurement unit 130 on the proximal end 110a, and the optical connection structure 1A according to the first embodiment is applied to a connected portion thereof, for example. The OCT device 100 rotates the optical connection structure 1A to rotate the optical fiber 11 on the distal end 110b. Observation light is scanned in the circumferential direction, and then, the OCT device 100 acquires an optical coherence tomography image in a predetermined range of the target site 103.

The measurement unit 130 includes a light source 131 generating a light, a light dividing unit 132 dividing the light emitted from the light source 131 into two pieces to output as observation light and reference light, a light detecting unit 133 detecting the light reaching from the light dividing unit 132, a light terminal 134 outputting the reference light reaching from the light dividing unit 132, a reflecting mirror 135 reflecting the reference light output from the light terminal 134 to the light terminal 134, an analyzing unit 136 analyzing a spectrum of the light detected by the light detecting unit 133, and an output port 137 outputting a result of the analysis by the analyzing unit 136.

The light output from the light source 131 in the measurement unit 130 is divided into two pieces by the light dividing unit 132, and output as the observation light (L in FIG. 7) and the reference light. The observation light output from the light dividing unit 132 is incident via the optical connection structure on the proximal end 110a of the optical fiber 11, guided by the optical fiber 11 to be emitted from the distal end 110b, and shed on the target site 103. Back-reflected light generated in response to the irradiation of the observation light to the target site 103 is incident on the distal end 110b of the optical fiber 11, guided by the optical fiber 11 to be emitted from the proximal end 110a, passed through the optical connection structure and the light dividing unit 132, and coupled to the light detecting unit 133. The light generated from the light source 131 includes infrared light used as observation light and reference light, and visible light used as guide light. The guide light is light for an operator to recognize an irradiation position of the observation light, and is emitted from the distal end 110b similar to the observation light.

The reference light output from the light dividing unit 132 is emitted from the light terminal 134, reflected on the reflecting mirror 135, passed through the light terminal 134 and the light dividing unit 132, and coupled to the light detecting unit 133. The back-reflected light from the target site 103 interferes with the reference light in the light detecting unit 133, and the interfering light is detected by the light detecting unit 133. A spectrum of the interfering light is input to the analyzing unit 136. In the analyzing unit 136, the spectrum of the interfering light is analyzed to calculate a distribution of a back-reflection efficiency at each point in the target site 103. On the basis of a result of the calculation, a tomographic image of the target site 103 is calculated and output as image signals from the output port 137.

In a mechanism in which the observation light emitted from the distal end 110b of the optical fiber 11 comes back again via the target site 103 to the distal end 110b of the optical fiber 11, there are strictly reflection, refraction, and scattering. However, differences in them are not essential in the present disclosure, and they are collectively called a back reflection for the purpose of simplification.

The optical probe 110 includes a support tube 114 surrounding the optical fiber 11 and extending along the optical fiber 11, and a jacket tube 115 surrounding the support tube 114 and extending along the support tube 114, closer to the proximal end 110a than the handpiece 116. The optical fiber 11 is fixed to the support tube 114 with an adhesive or the like, and rotatable with the support tube 114. The jacket tube 115 is connected with the measurement unit 130 on a base end, and connected with the handpiece 116 on a tip end. The handpiece 116 is a part gripped by the operator.

For example, in a medical imaging system such as the OCT device 100 according to the embodiment, the optical probe 110 having the optical fiber 11 built therein is connected to the measurement unit 130 for use. In many cases, the optical probe 110 is disposable, and is replaced with a new optical probe 110 after one time using. Therefore, the optical connector on the optical probe 110 is repeatedly connected and detached. On the other hand, the optical connector on the measurement unit 130 is continuously used. Therefore, in a case where the optical connection structure of related art is used in which the end surfaces of the optical fibers are abutted against each other, if the attachment and detachment of the optical connector on the optical probe 110 are repeated, the end surface of the optical fiber of the optical connector on the measurement unit 130 is likely to be damaged so that the optical property degrades. In contrast, the embodiment uses the optical connection structure 1A according to the first embodiment such that the degradation of the optical property caused by the repetition of the attachment and detachment can be efficiently suppressed.

The optical connector and the production method thereof according to the present disclosure are not limited to the embodiments described above, and other various modification may be adopted. For example, the above embodiments and modification examples described above may be combined with each other depending on required object and effect. The above embodiments apply the present disclosure to the single-core fiber optical connector, but the present disclosure may be applied to a multi-core fiber optical connector. The above embodiments provide the ferrule cap to a single-core ferrule, but the ferrule cap may be provided to a multi-core ferrule.

### REFERENCE SIGNS LIST

1A . . . Optical connection structure, 10 . . . Optical connector, 11 . . . Optical fiber, 11a . . . End surface, 12 . . . Ferrule, 12a . . . Fiber inserted hole, 12b . . . Ferrule end surface, 13 . . . Matching film, 14, 14A, 14B . . . Ferrule cap, 14a . . . Light transmission portion, 14b . . . Rear surface, 14c . . . Lens, 14d . . . Tip end, 14e . . . End surface, 14f . . . Outer periphery, 14g . . . Step, 14h . . . Surface, 14i . . . Other end surface, 14j . . . End, 14k . . . Vacant hole, 16 . . . Flange, 16a . . . End surface, 17 . . . Hard member, 19 . . . Hard film, 20 . . . Housing, 21 . . . Inner housing, 22 . . . Outer housing, 23 . . . Step, 23a . . . Surface, 50 . . . Adapter, 51 . . . Split sleeve, 52, 53 . . . Opening, 100 . . . OCT device, A1 . . . First direction.

1. An optical connector, the optical connector being one of a pair of optical connectors connected to face each other along a first direction, the optical connector comprising:
a ferrule that holds an optical fiber, the ferrule exposing an end surface of the optical fiber from a ferrule end surface closer to the other optical connector in the first direction; and
a ferrule cap that covers the ferrule,
wherein the ferrule cap has a light transmission portion, a light path extending from the end surface of the optical fiber being made to pass through the light transmission portion, and
wherein an end of the ferrule cap except for the light transmission portion is positioned closer to the other optical connector with respect to the end-surface of the optical fiber and the light transmission portion in the first direction.

2. The optical connector according to claim 1, wherein the light transmission portion is made of a light transmissive material.

3. The optical connector according to claim 1, wherein the ferrule cap is entirely made of a light transmissive material.

4. The optical connector according to claim 2, wherein the light transmission portion has a lens optically coupled with the optical fiber.

5. The optical connector according to claim 2, wherein the ferrule end surface and the end surface of the optical fiber, and the light transmission portion are closely contact with each other.

6. The optical connector according to claim 2, further comprising:
an adhesive or a refractive index matching material arranged between the ferrule end surface and the end surface of the optical fiber, and the light transmission portion, the adhesive or the refractive index matching material matching refractive indexes of the optical fiber and the light transmission portion.

7. The optical connector according to claim 1, wherein the light transmission portion includes a vacant hole.

8. The optical connector according to claim 1,
wherein the ferrule end surface and the end surface of the optical fiber are inclined with respect to a plane perpendicular to an optical axis of the optical fiber, and
wherein the light transmission portion faces the ferrule end surface and the end surface of the optical fiber, and has a surface inclined along the ferrule end surface and the end surface of the optical fiber.

9. The optical connector according to claim 1, further comprising a housing that accommodates the ferrule and the ferrule cap therein, the housing having a first step on an inner wall,
wherein the ferrule cap has a second step on an outer surface, and the first step and the second step abut against each other such that the ferrule cap is restrained from moving relatively to the housing away from the other optical connector.

10. The optical connector according to claim 1, wherein the ferrule cap has a portion inserted into a sleeve accommodated in an adapter, the portion has a columnar surface-shaped outer periphery centered on the optical axis of the optical fiber, and a diameter of the outer periphery is 1.25 mm or 2.5 mm.

11. The optical connector according to claim 1, wherein the ferrule cap is configured to include a resin material, and the ferrule cap has a hard member or a hard film which has a hardness higher than the resin material and constitutes the one end.

12. The optical connector according to claim 1, further comprising a flange that supports the ferrule, wherein the ferrule cap is attached to the ferrule so as to provide a clearance between the ferrule cap and the flange.

13. An optical connector production method for producing the optical connector according to claim 1, wherein at least the light transmission portion in the ferrule cap is made of a resin material, and the method comprises a step of molding the ferrule and the ferrule cap to be one form using a direct molding method.
